(19) United States
(12) Patent Application Publication
(10) Pub. No.: US 2016/0233683 A1
(43) Pub. Date: Aug. 11, 2016

(54) SYSTEM AND APPARATUS PROVIDING POWER GENERATION AND DEMAND MANAGEMENT USING A THERMAL HYDRAULIC DC GENERATOR

(71) Applicant: Eric William Newcomb, Harrison, ME (US)

(72) Inventor: Eric William Newcomb, Harrison, ME (US)

(21) Appl. No.: 14/847,724

(22) Filed: Sep. 8, 2015

Related U.S. Application Data
(63) Continuation of application No. 13/134,343, filed on Sep. 7, 2011, now abandoned.

(51) Int. Cl. H02J 3/46; H02J 3/40; H02K 7/18

(52) U.S. Cl. CPC H02J 3/46; H02K 7/1853; H02J 3/40

(57) ABSTRACT

Systems and apparatus providing power generation and demand management using a thermal hydraulic DC generator.

### FIELD OF THE INVENTION

The invention relates to the field of power generation and, more particularly but not exclusively, power generation systems using a Thermal Hydraulic DC Generator.

### BACKGROUND

Thermal Hydraulic DC Generators capture energy from Turbine Generators, Combustion Engines, Geothermal Sources, Facility Systems, or Solar Collectors. These sources can be used to produce 180-degree Fahrenheit hot water in order to drive Thermal Hydraulic DC Generators. These Generators create a very efficient means of generating electric power.

### SUMMARY

Various deficiencies in the prior art are addressed by systems and apparatus providing power generation and demand management using a thermal hydraulic DC generator. Various embodiments comprise a thermal hydraulic DC generator, for generating DC output power in response to a control signal; a grid tie inverter, for converting the DC output power into AC power for use by an electrical load; and a controller, for adapting said control signal in response to an electrical system load demand associated with said electrical load, said control signal being adapted to cause said thermal hydraulic DC generator to adapt said DC output power such that said grid tie inverter satisfies said electrical system load demand.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a system according to an embodiment;

FIG. 2 graphically depicts physical dimensions of an exemplary Programmable Logic Controller (PLC) suitable for use as a controller within the system of FIG. 1;

FIG. 3 graphically depicts exemplary power and signal input terminals associated with the PLC of FIG. 2;

FIGS. 4A-4B graphically depict exemplary wiring configurations for signal output terminals associated with the PLC of FIG. 2;

FIGS. 5A-5B graphically depict exemplary wiring configurations for connecting sensors/transmitters to signal input terminals associated with the PLC of FIG. 2.

FIG. 6 graphically depicts an exemplary wiring configuration for connecting an output device to signal output terminals associated with the PLC of FIG. 2;

FIGS. 7A-7B graphically depict exemplary wiring configurations for connecting a Resistance Temperature Detector (RTD) to excitation and sense input terminals of the PLC of FIG. 2;

FIGS. 8A-8B graphically depict physical dimensions of an exemplary user interface device associated with the PLC of FIG. 2;

FIGS. 9A-9D graphically depict physical dimensions for various VFDs suitable for providing circulation pump control functionality in the system of FIG. 1 in cooperation with the PLC of FIG. 2;

FIG. 10 depicts a schematic diagram of an exemplary inverter suitable for use as a grid tie inverter within the system of FIG. 1;

FIG. 11 graphically depicts a generator suitable for use within the system of FIG. 1; and

FIG. 12 graphically depicts PWM synthesis of a sinusoidal waveform.

To facilitate understanding, identical reference numerals have been used, where possible, to designate identical elements that are common to the figures.

### DETAILED DESCRIPTION

Thermal Hydraulic DC Generators capture energy from Turbine Generators, Combustion Engines, Geothermal Sources, Facility Systems, or Solar Collectors. These sources can be used to produce 180-degree Fahrenheit hot water in order to drive Thermal Hydraulic DC Generators. These Generators create a very efficient means of generating electric power.

Other co-generation systems require the use of steam to drive Steam Turbines. The use of steam as opposed to hot water requires more expensive equipment and more maintenance to operate than a 180 Degree F. hot water system. These 180 Degree F hot water systems incorporating the Thermal Hydraulic DC Generators are more efficient than the Rankine Cycle or the Carnot Cycle.

Thermal Hydraulic DC Generator Engines incorporate a PLC based control system that eliminates the need for governors and voltage regulators. They incorporate inverter systems to create “clean” power at unity power factor. This is a new system that has never been accomplished before.

The technological innovation regarding the Thermal Hydraulic DC Generator revolves around regulating the flow of the hydraulic fluid to the hydraulic pump and creating the correct RPM for the DC Generator. The load demands of the building electrical system are matched through the PLC based control system and instrumentation. The generator governor and regulator have been replaced by the PLC based control system. The correct flow of hydraulic fluid is supplied to the hydraulic pump. The DC output from the generator is connected to an inverter that corrects the AC output to a unity power factor. This is a new system that has never been accomplished before.

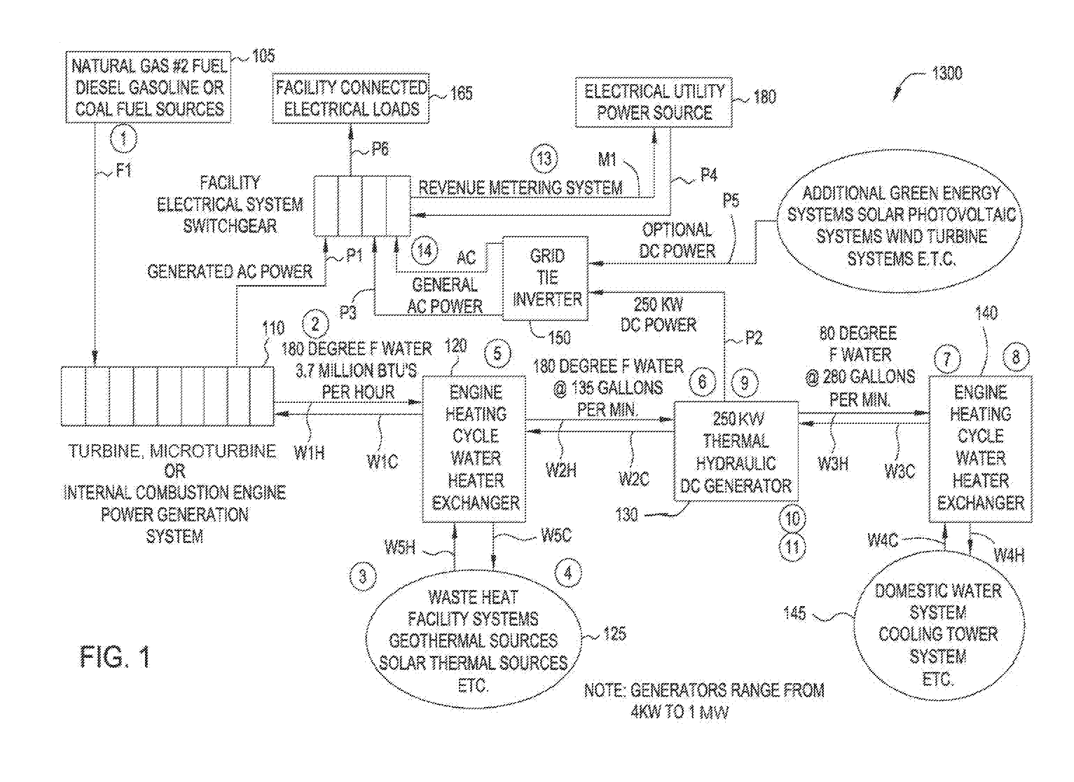

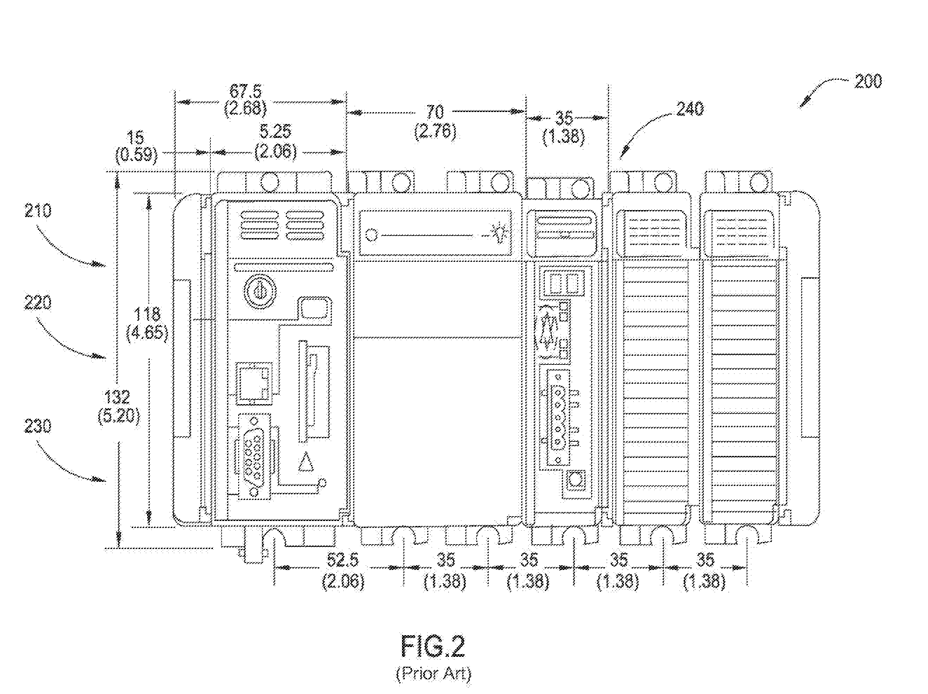

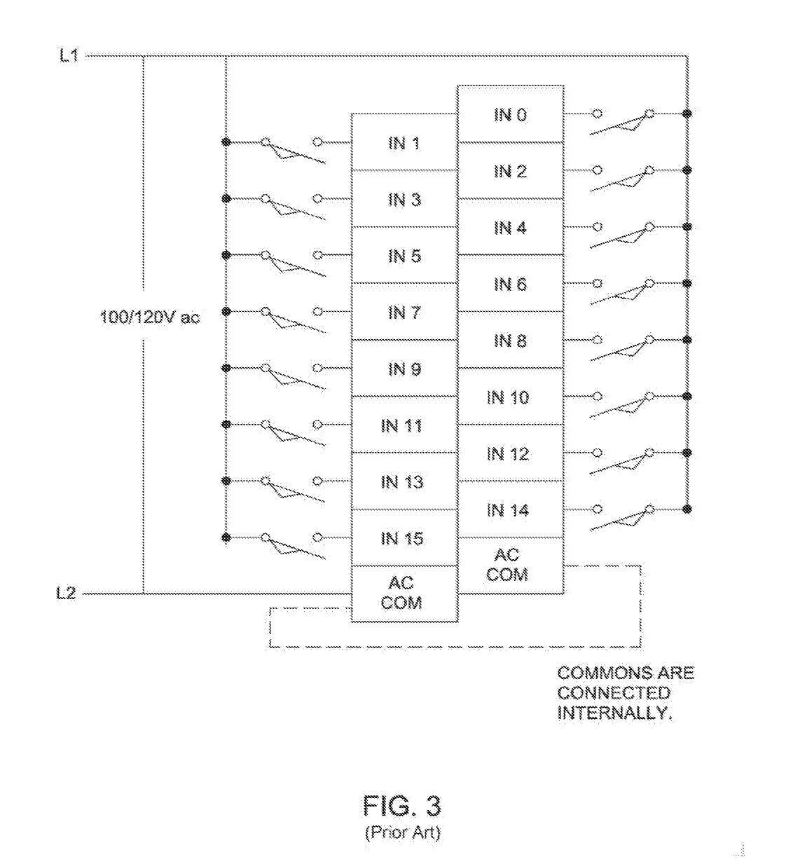

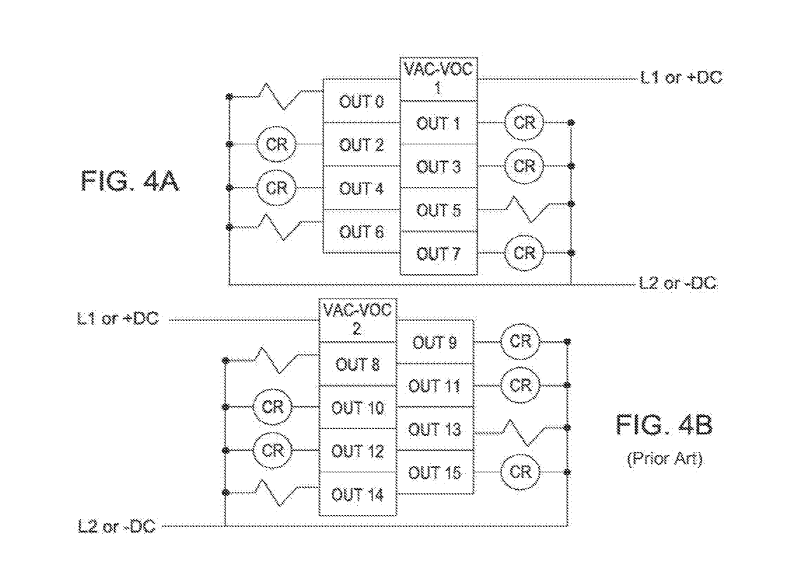

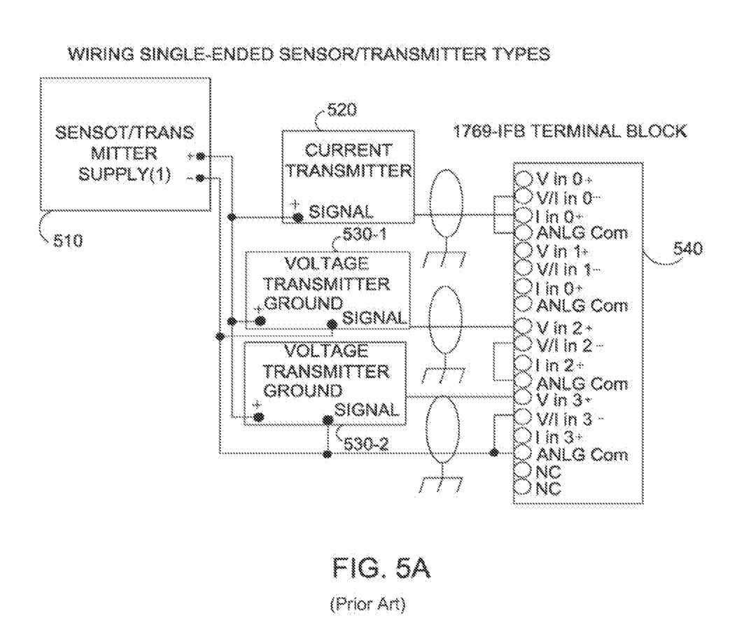

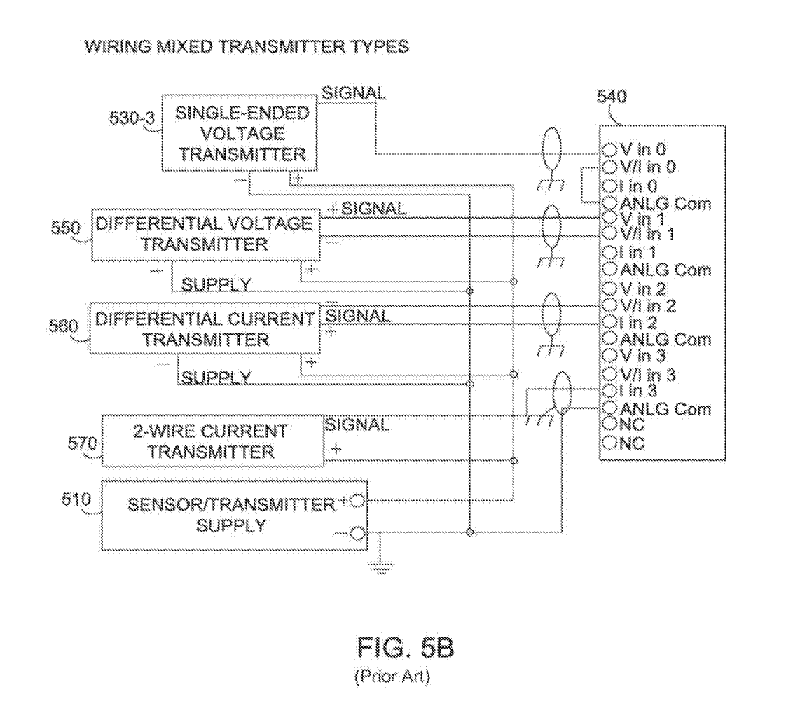

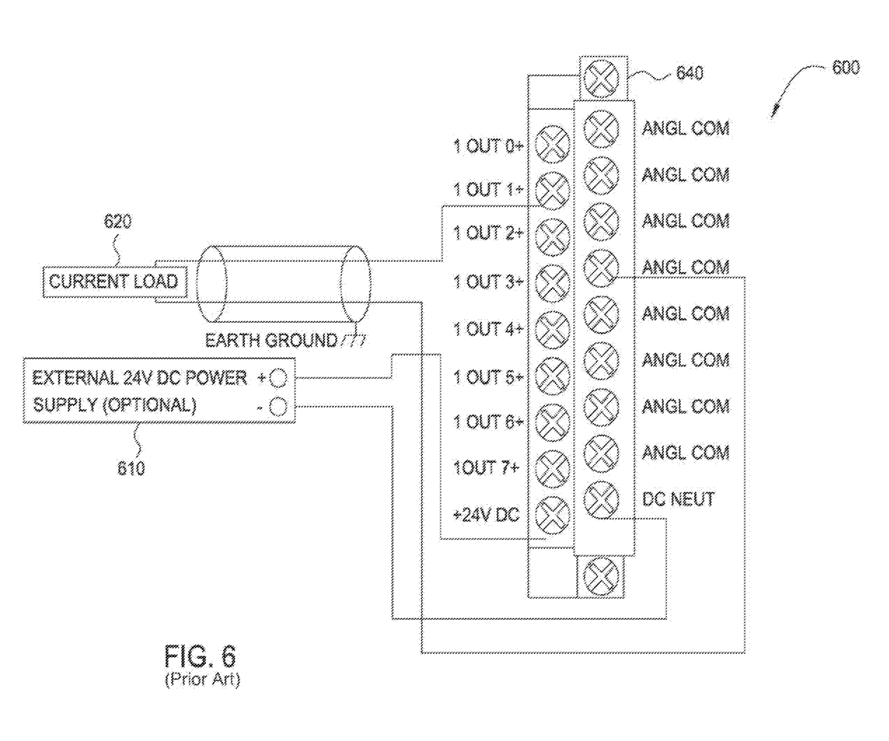

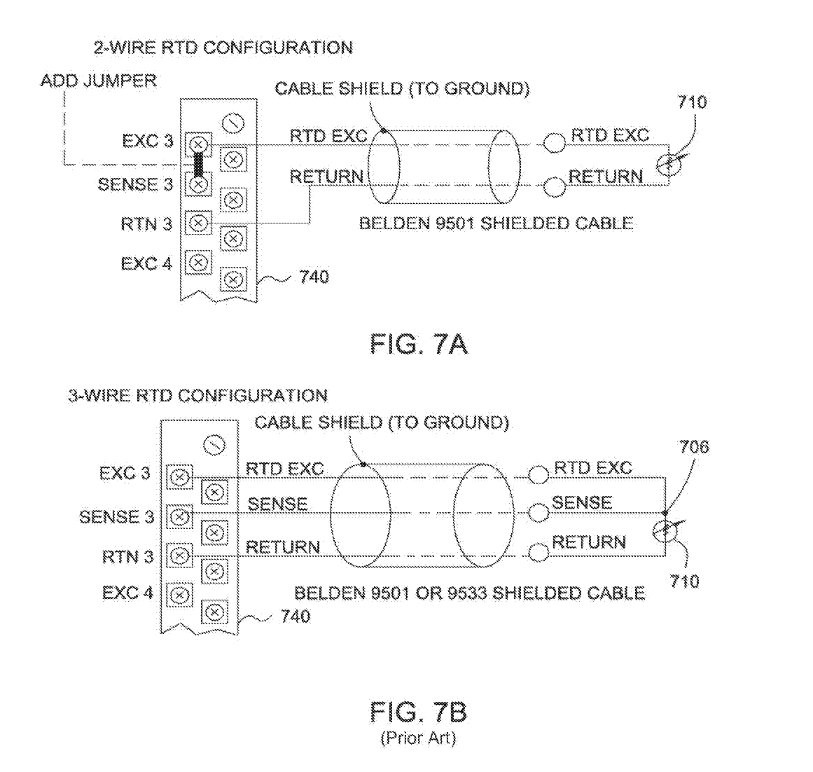

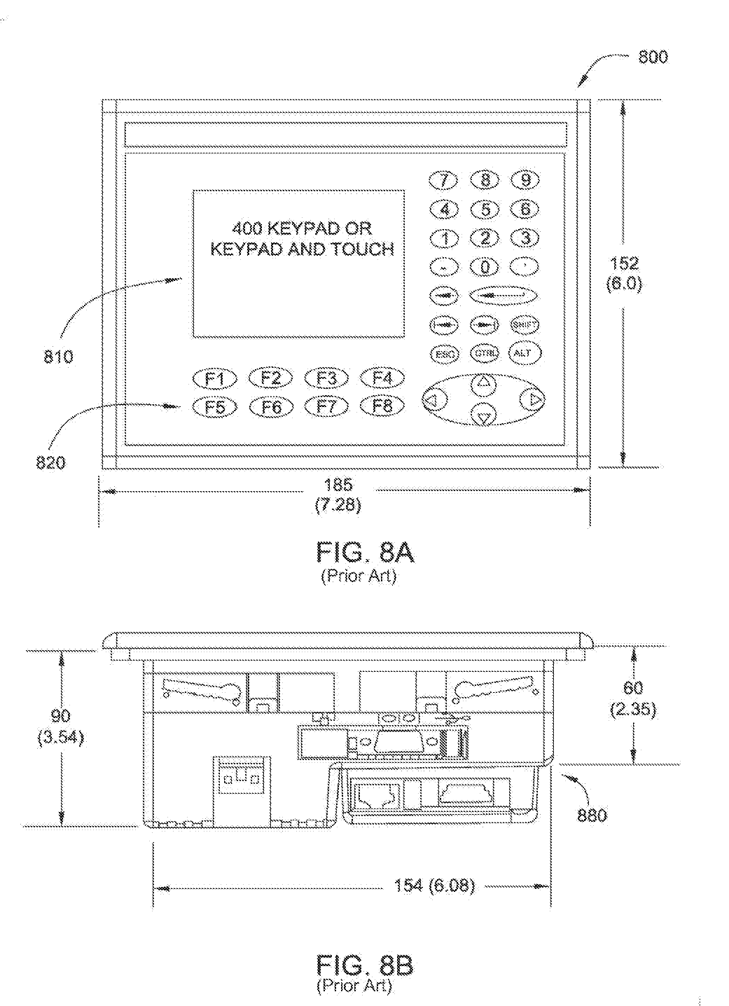

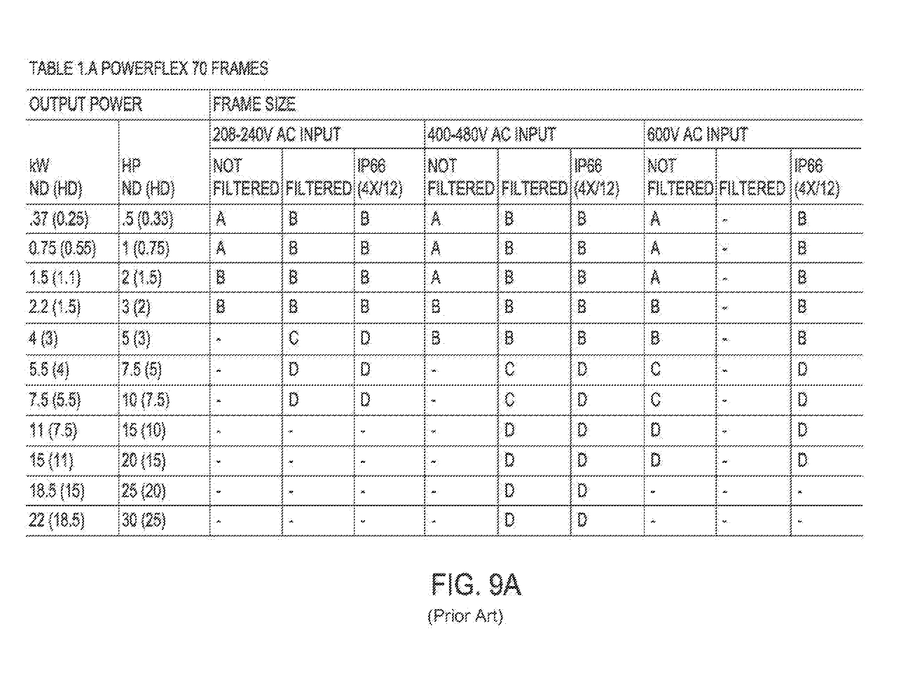

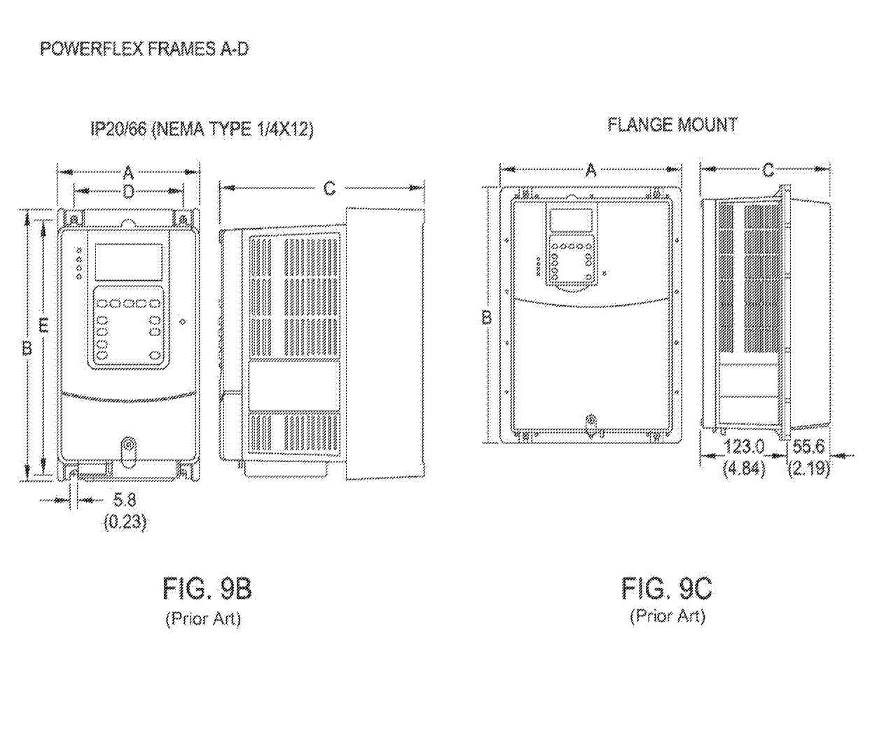

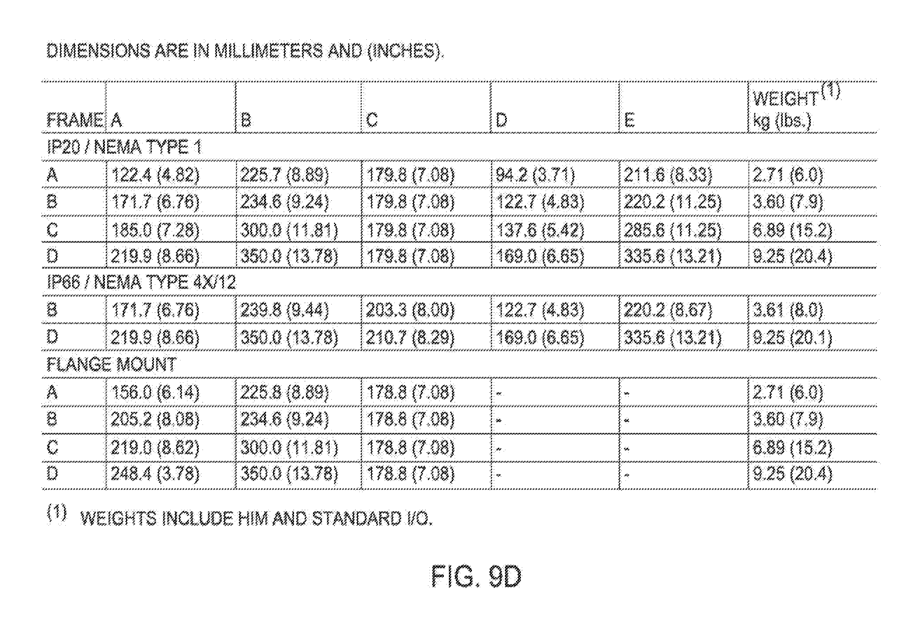

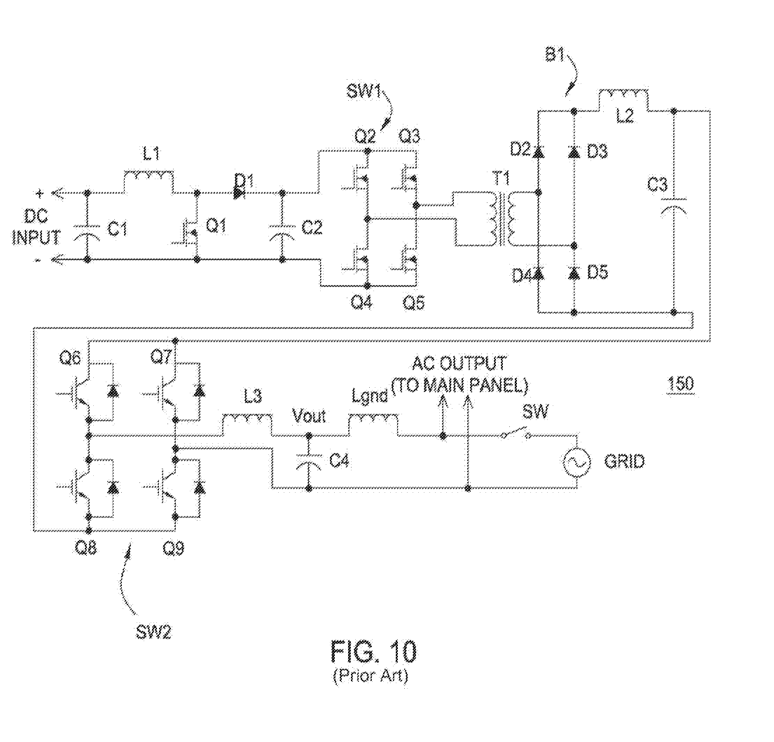

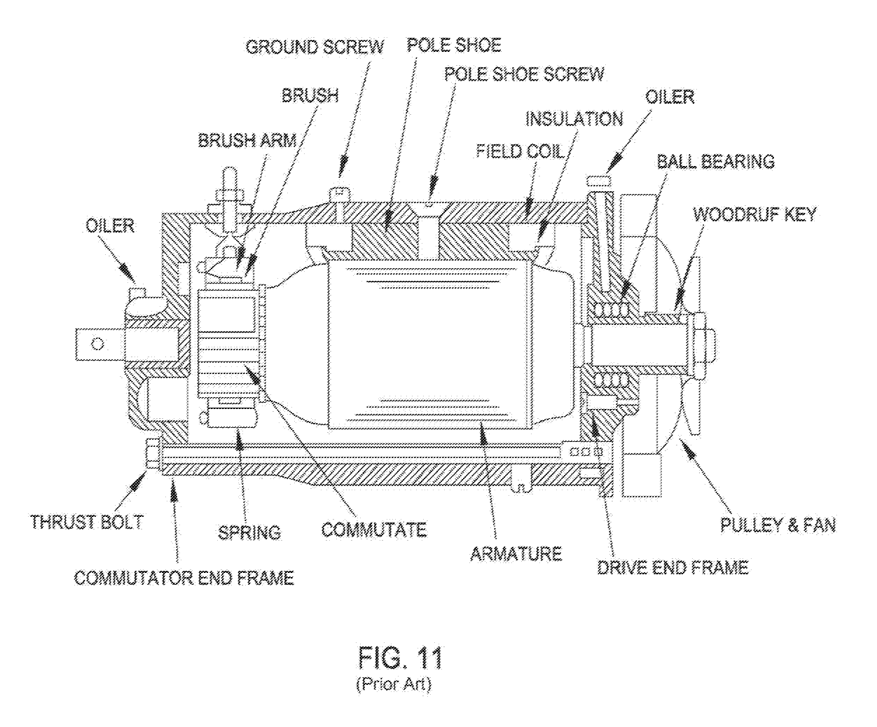

Various embodiments are described within the context of the figures. FIG. 1 represents a flow diagram for a Thermal Hydraulic DC Generator connected to a microturbine system to capture waste heat from the exhaust and increase the efficiency of the overall system. FIG. 2 represents a 32 bit microprocessor with Ethernet communications for the PLC based control system. FIG. 3 represents a discreet input module used for the PLC based control system. FIGS. 4A-4B represent a discreet output module for the PLC based control system. FIGS. 5A-5B represents an analog input module for the PLC based control system. FIG. 6 represents an analog output module for the PLC based control system. FIGS. 7A-7B represent an RTD input module for the PLC based control system. FIGS. 8A-8B represent an operator interface terminal used for the PLC based control system. FIGS. 9A-9D represent a VFD used for circulation pump control with the PLC based control system. FIG. 10 represents a grid tie inverter that will be used to convert DC power to AC Power and synchronize with the utility power grid at unity power factor. A Process description is also included. FIG. 11 represents a DC generator used to generate DC power.

FIG. 1 depicts a high level block diagram of a system according to an embodiment. Generally speaking, FIG. 1 depicts a flow diagram for a Thermal Hydraulic DC Generator connected to a microturbine system to capture waste heat from the exhaust and increase the efficiency of the overall system.

Referring to FIG. 1, a system 100 includes a fuel source 105 (e.g., natural gas, #2 fuel, diesel, gasoline, coal or other fuel source), a power generation system 110 (illustratively a turbine, micro-turbine, internal combustion engine or other power generation system), an engine heating cycle water heat exchanger 120, optional heat sources 125 (illustratively waste heat from facility systems, heat from geothermal sources, heat from solar thermal sources etc.), a thermal hydraulic DC generator 130 (illustratively a 250 kW generator, or other generator ranging from 4 kW to 1 MW), an engine cooling cycle water heat exchanger 140, cooling sources 145 (illustratively a domestic water system, a cooling tower system etc.), a grid tie inverter 150, facility electrical system switchgear 160, facility connected electrical loads 165, optional additional green energy systems 170 (illustratively solar photovoltaic systems, wind turbine systems etc.) and an electrical utility power source 180.

The power generation system 110 receives fuel from the fuel source 105 via path F1, and generates AC power which is coupled to facility electrical system switchgear 160 via path P1.

The engine heating cycle water heat exchanger 120 receives 180° F. water from the power generation system 110 via path W1H (illustratively at 3.7 million BTUs per hour), and returns cooler water to the power generation system 110 via path W1C.

The engine heating cycle water heat exchanger 120 may receive hot water from optional heat sources 125 via path W5H, and return cooler water to the optional heat sources 125 via path W5C.

The engine heating cycle water heat exchanger 120 provides hot water to the thermal hydraulic DC generator 130 via path W2H, and receives cooler water from the thermal hydraulic DC generator 130 via path W2C. In the illustrated embodiment, path W2H supplies 180° F. water at a rate of 135 gallons per minute to a 250 kW thermal hydraulic DC generator 130.

The thermal hydraulic DC generator 130 provides hot water to the engine cooling cycle water heat exchanger 140 via path W3H, and receives cooler water from the engine cooling cycle water heat exchanger 140 via path W3C. In the illustrated embodiment, path W3C supplies 80° F. water at a rate of 280 gallons per minute to a 250 kW thermal hydraulic DC generator 130.

The engine cooling cycle water heat exchanger 140 provides hot water to cooling sources 145 via path W4H, and receives cooler water from the cooling sources 145 via path W4C.

The thermal hydraulic DC generator 130 generates DC power in response to the temperature differential between the 180° F. water provided via the W2H/W2C fluid loop and the 80° F. water provided via the W3H/W3C fluid loop. The DC power, illustratively 250 kW AC power, is provided to grid tie inverter 150 via path P2.

Grid tie inverter 150 may also receive additional DC power via path P5 from optional additional green energy systems 170.

Grid tie inverter 150 operates to invert received DC power to thereby generate AC power which is coupled to facility electrical system switchgear 160. Grid tie inverter 150 “ties” DC power to the electrical grid by inverting the DC power such that the resulting generated AC power conforms to power grid specifications.

Facility electrical system switchgear 160 receives AC power from electrical utility power source 180 via path P4, and provides revenue metering system information to electrical utility power source 180 via M1.

Facility electrical system switchgear 160 operates to supply AC power to facility connected electrical loads 165, the supplied AC power comprising power from one or more of power generation system 110, grid tie inverter 150 and electrical utility power source 180.

An operating methodology associated with the system 100 of FIG. 1 will now be described with respect to the below steps, each of which is indicated in FIG. 1 by a corresponding circled number.

Step 1. Natural Gas, Methane, #2 Fuel Oil, or Diesel Fuel can be used to power Turbine Generators or Combustion Engine Generators that produce electricity and synchronize with the utility electrical system by the use of an inverter at unity power factor.

Step 2. The exhaust from the Turbine Generators or Combustion Engine Generators Heat circulated water through manifolds or engine water jackets.

Step 3. Additional energy is recovered from the Turbine Generators or Combustion Engine Generators exhaust systems through the use of an air over water secondary heat exchanger that is incorporated with the same hot water closed loop system as the manifolds or the water jackets.

Step 4. Additional energy can be recovered from other building systems through the use of a water/steam over water secondary heat exchanger, Geothermal Sources, or Solar Collectors that are incorporated with the same hot water closed loop system as the Turbine Generators or Combustion Engine manifolds or water jackets.

Step 5. The temperature of the hot water closed loop system is regulated at 180 degrees F. by the use of variable frequency drive (VFD) controlled circulating pumps. The temperature is a function of the water flow in the system. The flow of the water is regulated by the rpm of the circulating pumps. The VFD's are controlled by a PLC based control system. PID loops in the PLC program monitor and control the temperature, pressure, and flow of the hot water loop. These PID loops control the VFD output and the rpm of the circulating pumps. The heating water that returns from the Thermal Hydraulic DC Generator Engine is at approximately 150 degrees F.

Step 6. The 180-degree F water is circulated through a Thermal Hydraulic DC Generator Engine. The water is used to expand liquid carbon dioxide which in turn drives a piston in one direction. A solenoid valve that is controlled by the PLC based control system controls the water flow. The liquid carbon dioxide does not experience a phase change. The Thermal Hydraulic DC Generator Engine does not involve an intake and exhaust cycle. It is very efficient and has a very long life expectancy with minimal maintenance requirements.

Step 7. An 80-degree F cooling-water closed loop system is also required to operate the Thermal Hydraulic DC Generator Engine. This cooling-water loop is circulated through a sanitary water over water heat exchanger that is installed in the domestic water system or through a water over water heat exchanger that is connected to a cooling tower or a cooling water piping system in the ground. The domestic water temperature is usually around 70-80 Degrees F. The cooling water that returns from the Thermal Hydraulic DC Generator Engine is at approximately 100 degrees F.

Step 8. The temperature of the cooling water closed loop system is regulated by the use of variable frequency drive controlled circulating pumps. The temperature is a function of the water flow in the system. The flow of the water is regulated by the rpm of the circulating pumps. The VFD's are controlled by a PLC based control system. PID loops in the PLC program monitor and control the temperature, pressure, and flow of the hot water loop. These PID loops control the VFD output and the rpm of the circulating pumps. The heating water that returns from the Thermal Hydraulic DC Generator Engine is at approximately 170 degrees F.

Step 9. The 80-degree F water is circulated through a Thermal Hydraulic DC Generator Engine. The water is used to contract liquid carbon dioxide, which in turn drives a piston in the opposite direction from expanded liquid carbon dioxide. A solenoid valve that is controlled by a PLC based control system controls the water flow.

Step 10. The Thermal Hydraulic DC Generator Engine drives a hydraulic pump. The pistons moving back and forth pump hydraulic fluid. The flow of the hydraulic fluid is regulated by PID loops in the PLC based control system. The PLC program coordinates the opening and closing of the solenoid valves for the heating and cooling water loops with the required flow rate of the hydraulic fluid.

Step 11.The hydraulic pump drives a DC generator. The DC generator is connected to a grid tie inverter which synchronizes with the building electrical system at unity power factor. The term for this device is a “Thermal Hydraulic DC Generator”. This is a new concept. It has never been accomplished before.

Step 12. Additional “Green Energy” systems can be connected to the same grid tie inverter in order to synchronize with the building electrical system. These systems can include solar photovoltaic modules and wind Turbine systems.

Step 13. Revenue metering is established to monitor the power sold to the utility when the total generation exceeds the demand for the building systems.

Step 14. In cases where revenue metering is not allowed by the utility, the number of Micro Turbines that are synchronized to the building electrical system can be controlled by the PLC based control system. In this case the demand for the building will have to exceed the total amount of power that is generated.

In various embodiments, the PLC based control system performs the following functions:
1. Regulate the temperatures, pressures and flow rates for the heating cycle and cooling cycle water system.
2. Regulate the temperatures, pressures and flow rates for the hydraulic systems.
3. Control the firing rate of the solenoid valves to regulate the engine speed.
4. Control the inverter output.
5. Control associated generation systems.
6. Monitor the electrical system load demand.
7. Communicate with multifunction relays associated with the utility service.
8. Data Collection System
9. Alarm system

In various embodiments, the PLC based control system utilizes the following devices:
1. 32 bit microprocessor
2. Analog Input Module
3. Analog Output Module
4. Discreet Input Module
5. Discreet Output Module
6. RTD Temperature Sensors
7. Differential Pressure Transmitters
8. Flow Meters
9. Variable Frequency Drives
10. Multifunction Protective Relays
11. Current Sensors
12. Voltage sensors
13. Frequency Sensors
14. Operator Interface Terminal
15. Data Collection System
16. Alarm System

FIG. 2 graphically depicts physical dimensions of an exemplary Programmable Logic Controller (PLC) suitable for use as a controller within the system of FIG. 1. In various embodiments, the PLC comprises a 32 bit microprocessor-based PLC with Ethernet communications, such as the model 1769-L32C or 1769-L35CR CompactLogix Controller manufactured by Rockwell Automation. It can be seen by inspection that the exemplary PLC 200 of FIG. 2 includes various connection an interface elements such as central processing unit (CPU) connectors 210, control network connectors 220, channel input/output connectors 230, user or operator input/output interface devices 240 and the like. Generally speaking and as known in the art, the PLC 200 of FIG. 2 comprises a device including a processor, memory and input/output circuitry which may be programmed to monitor various digital and/or analog input signals and responsively adapts various output signal levels or data/communication sequences in response to such monitoring.

FIG. 3 graphically depicts exemplary power and signal input terminals associated with the PLC of FIG. 2. Specifically, FIG. 3 represents a discreet input module used for the PLC based control system. It can be seen by inspection that the power terminals are responsive to a line or grid voltage of 100/120 VAC (in this embodiment) and that various input devices may be coupled to the signal input terminals.

FIGS. 4A-4B graphically depict exemplary signal output terminals associated with the PLC of FIG. 2. Specifically, FIGS. 4A-4B represent wiring configurations for a discreet output module for the PLC based control system comprising, illustratively, a 16-point AC/DC Relay Output Module. It can be seen by inspection that the relay output module is adapted to be grounded in a particular manner.

FIGS. 5A-5B graphically depict exemplary wiring configuration for connecting sensors/transmitters to signal input terminals associated with the PLC of FIG. 2.

FIG. 5A graphically depicts an exemplary wiring configuration for connecting single-ended sensor/transmitter types to signal input terminals associated with the PLC of FIG. 2. It can be seen by inspection that a sensor/transmitter power supply 510 cooperates with a current sensor/transmitter 520 and a plurality of voltage sensor/transmitters 530. The current sensor/transmitter 520 provides an output signal adapted in response to a sensed parameter, which output signal is provided to a current sensor input terminal (I in 0+) of a terminal block 540. The voltage sensor/transmitters 530 provide output signals adapted in response to respective sensed parameters, which output signals are provided to respective voltage sensor input terminals (V in 2+ and V in 3+) of the terminal block 540.

FIG. 5B graphically depicts an exemplary wiring configuration for connecting mixed transmitter types to signal input terminals associated with the PLC of FIG. 2. It can be seen by inspection that a sensor/transmitter power supply 510 cooperates with a single ended voltage sensor/transmitter 530, a differential voltage sensor/transmitter 550, a differential current sensor/transmitter 560 and a 2-wire current sensor/transmitter 570. Each of the sensor/transmitter types 530, 550, 560 and 570 provides an output signal adapted in response to a respective sensed parameter, which output signal is provided to a respective input terminal of a terminal block 540.

FIG. 6 graphically depicts an exemplary wiring configuration for connecting an output device to signal output terminals associated with the PLC of FIG. 2. Specifically, FIG. 6 represents an analog output module for the PLC based control system. It can be seen by inspection that an optional external 24 V DC power supply is connected between an DC neutral terminal and a +24 VDC terminal of a terminal block 640, while a shielded cable 620 provides current to a load (not shown) load, the current sourced from a current output terminal (I out 1+) of the terminal block 640.

FIGS. 7A-7B graphically depict an exemplary wiring configuration for connecting a Resistance Temperature Detector (RTD) to excitation and sense input terminals of the PLC of FIG. 2.

FIG. 7A graphically depicts an exemplary wiring configuration for connecting a 2-wire Resistance Temperature Detector (RTD) to excitation and sense input terminals of the PLC of FIG. 2. It can be seen by inspection that an RTD 710 is coupled between bridged excitation (EXC 3) and sense (SENSE 3) terminals at a terminal block 740, and a return terminal (RTN 3) at the terminal block 740. Current sourced from the excitation/sensor terminals passes through the RTD 710 and returns to the return terminal. It is also noted that a two-conductor shielded cable, illustratively a Belden 9501 Shielded Cable, is used to connect the excitation/sense wire (RTD EXC) and return wire (Return) between the RTD 710 and terminal block 740. The shield of the shielded cable is coupled to ground.

FIG. 7B graphically depicts an exemplary wiring configuration for connecting a 3-wire Resistance Temperature Detector (RTD) to excitation (EXC 3), sense (SENSE 3) and return (Return) terminals at a terminal block 740 of the PLC of FIG. 2. It can be seen by inspection that an RTD 710 is coupled between a junction or connection 706 proximate the RTD 710 of an excitation signal wire (RTD EXC) and a sense signal wire (Sense), and a return signal wire (Return). It is also noted that a three-conductor shielded cable, illustratively a Belden 83503 or 9533 Shielded Cable, is used to connect the excitation wire (RTD EXC), sense wire (sense That) and return wire (Return) between the RTD 710 and terminal block 740. The shield of the shielded cable is coupled to ground.

FIGS. 8A-8B graphically depict physical dimensions of an exemplary user interface device associated with the PLC of FIG. 2, illustratively an operator interface terminal 800 used for the PLC based control system. FIG. 8A depicts a front view of the operator interface terminal 800, while FIG. 8B depicts a plan view of the operator interface terminal 800. It can be seen by inspection that the exemplary operator interface terminal 800 comprises a PanelView Plus 400 or 600 terminal manufactured by Allen-Bradley. The terminal 800 includes a keypad or keypad/touch screen 810/820. Generally speaking, the terminal includes circuitry supporting user input to the PLC (e.g., keypad or touch screen input), as well as circuitry providing user output from the PLC (e.g., display screen). As is known in the art, the terminal 800 is used to facilitate programming of the various functions of the PLC 200, such as those described herein as implemented via the PLC 200 and the various embodiments. It is also noted that the terminal includes various network and communication ports 830 as shown in

FIGS. 9A-9D graphically depict physical dimensions for various VFDs suitable for providing circulation pump control functionality in the system of FIG. 1 in cooperation with the PLC of FIG. 2, illustratively one of the PowerFlex 70 frames manufactured by Rockwell Automation. FIG. 9A depicts a table listing output power for various PowerFlex 70 frame sizes. FIGS. 9B-9C depict physical dimensions associated with PowerFlex 70 Frames A-D as indicated in the table of FIG. 9A. FIG. 9D depicts a table listing physical mounting options associated with various PowerFlex 70 frame sizes.

FIG. 10 depicts a schematic diagram of an exemplary inverter suitable for use as a grid tie inverter within the system of FIG. 1. Specifically, FIG. 10 represents a grid tie inverter the grid tie inverter 150 150 10 of FIG. 10 is used to convert DC power to AC Power and synchronize the AC power with the utility power grid at unity power factor. Referring to FIG. 10, components associated with grid tie inverter 150 are configured as follows:

A DC input voltage is received across an input capacitor C1. A first inductor L1 and a first transistor Q1 (illustratively an N-channel IGFET) are connected in series in the order named between positive and negative terminals of the input capacitor C1.

A forward biased diode D1 and second capacitor C2 are connected in series in the order named between a source and a drain of transistor Q1 (i.e., anode of diode D1 connected to source of transistor Q1, cathode of diode D1 connected to positive terminal of capacitor C2).

A first switching circuit SW1 connected between positive and negative terminals of capacitor C2 operates to switch or chop the voltage across capacitor C2. The switching circuit SW1 comprises, illustratively, four transistors Q2-Q5 (illustratively an N-channel IGFETs) configured in a known manner to drive a switched power signal through a input coil of a transformer T1.

An output coil of transformer T1 provides a resulting switched or chopped signal to a full wave bridge rectifier B1 formed in a known manner using four diodes D2-D5 to provide thereby a rectified (i.e., substantially DC) signal.

A second inductor L2 and a third capacitor C3 are connected in series in the order named between positive and negative outputs of the full wave bridge rectifier B1.

A second switching circuit SW2 connected between positive and negative terminals of capacitor C3 operates to switch or chop the voltage across capacitor C3. The switching circuit SW1 comprises, illustratively, four transistors to 6-29 (illustratively an NPN transistors having respective diodes forward biased between emitter and collector terminals.) configured in a known manner to a series drive a switched power signal through a third inductor L3 and a fourth capacitor C4, L3 and C4 being connected in series in the order named.

An inductive element Lgrid (representative of power grid inductance), a switch SW and the power grid itself are connected in series in the order named between positive and negative terminals of capacitor C4.

An AC output signal between the Lgrid/SW junction point and the negative terminal capacitor C4 is provided as an AC output to the main panel.

Referring to FIGS. 1 and 10, various operations of the grid tie inverter 150 within the context of the system 100 will now be described.

Operating a renewable energy system in parallel with an electric grid requires special grid interactive or grid tie inverters (GTI). The power processing circuits of a GTI are similar to that of a conventional portable power inverter. The main differences are in their control algorithm and safety features.

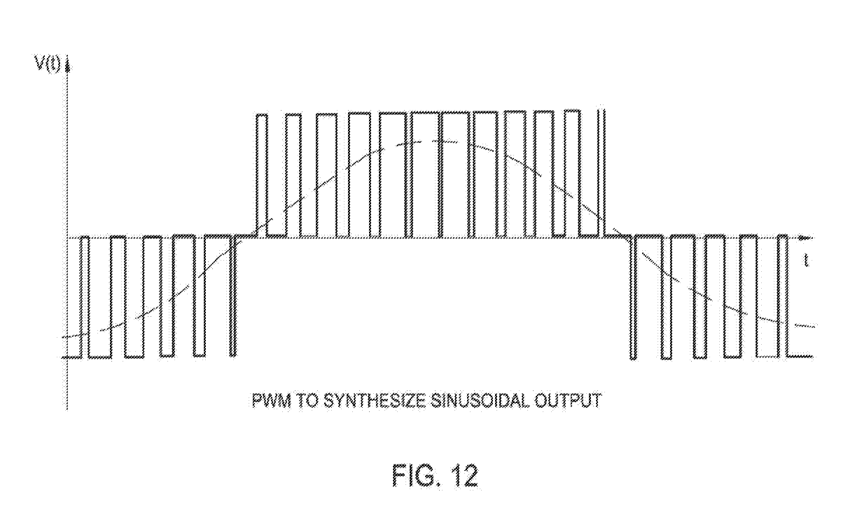

A GTI typically takes the DC voltage from the source, such as an solar panels array or a wind system, and inverts it to AC. It can provide power to your loads and feed an excess of the electricity into the grid. The GTIs are normally two-stage or three-stage circuits. The simplified schematic diagram shown in FIG. 12 illustrates the PWM to sinusoidal waveshape operation of a grid tie inverter with three power stages. Such power train can be used for low-voltage inputs (such as 12V). The control circuits and various details are not shown here.

The DC input voltage is first stepped up by the boost converter formed with inductor L1, MOSFET Q1, diode D1 and capacitor C2. If PV array is rated for more than 50V, one of the input DC busses (usually the negative bus) has to be grounded per National Electric Code®.

Since the AC output is connected to the grid, in such case the inverter has to provide a galvanic isolation between the input and output. In our example the isolation is provided by a high frequency transformer in the second conversion stage. This stage is a basically a pulse-width modulated DC-DC converter. Note that some commercial models use low-frequency output transformer instead of a high frequency one. With such method low voltage DC is converted to 60 Hz AC, and then a low-frequency transformer changes it to the required level. The schematic above shows a full bridge (also known as H-bridge) converter in the second stage. For power levels under 1000 W it could also use a half-bridge or a forward converter. In Europe, grounding on DC side is not required, the inverters can be transformerless. This results in lower weight and cost.

The transformer T1 can be a so-called step-up type to amplify the input voltage. With a step-up transformer, the first stage (boost converter) may be omitted. The isolating converter provides a DC-link voltage to the output AC inverter. Its value must be higher than the peak of the utility AC voltage. For example, for 120 VAC service, the DC-link should be >120*√2=168V. Typical numbers are 180-200V. For 240 VAC you would need 350-400 V.

The third conversion stage turns DC into AC by using another full bridge converter. It consists of IGBT Q6-Q9 and LC-filter L3, C4. The IGBTs Q6-Q9 work as electronic switches that operate in Pulse Width Modulation (PWM) mode. They usually contain internal ultrafast diodes. By controlling different switches in the H-bridge, a positive, negative, or zero voltage can be applied across inductor L3. The output LC filter reduces high frequency harmonics to produce a sine wave voltage.

A grid tie power source (i.e., grid tie inverter 150) operates to synchronize its frequency, phase and amplitude with the utility and feed a sine wave current into the load. Note that if inverter output voltage (Vout) is higher than utility voltage, the GTI will be overloaded. If it is lower, GTI would sink current rather than source it. In order to allow the electricity flow back into the grid, “Vout” has to be just slightly higher than the utility AC voltage. Usually there is an additional inductor (Lgrid) between GTE output the grid that “absorbs” extra voltage. It also reduces the current harmonics generated by the PWM. A drawback of “Lgrid” is it introduces extra poles in the control loop, which may lead to the system instability.

In solar applications, to maximize the system efficiency, a GTI has to meet certain requirements defined by the photovoltaic panels. Solar panels provide different power in different points of their volt-ampere (V-I) characteristic. The point in the V-I curve where output power is maximum is called maximum power point (MPP). The solar inverter must assure that the PV modules are operated near their MPP. This is accomplished with a special control circuit in the first conversion stage called MPP tracker (MPPT).

A GTI also has to provide so-called anti-islanding protection. When grid fails or when utility voltage level or frequency goes outside of acceptable limits, the automatic switch SW quickly disconnects “Vout” from the line. The clearing time must be less than 2 seconds as required by UL 1741.

The implementation of control algorithm of grid tie inverters is quite complex implemented with microcontrollers.

FIG. 11 graphically depicts a generator suitable for use within the system of FIG. 1. Specifically, FIG. 11 represents a DC generator used to generate DC power.

Various embodiments provide a novel Thermal Hydraulic DC Generator. The inventor notes that a person in the relevant technical field would think that it would not be possible to use this combination of devices for the following reasons:

People in this field would not realize that the regulation of the hydraulic fluid in the Thermal Hydraulic DC Generator Engine to drive the Thermal Hydraulic DC Generator RPM at the correct speed could be achieved. This will eliminate the need for a regulator and an engine speed governor that is typically required for an engine/generator package. This will require a PLC based control system with the correct instrumentation devices.

People in this field would not realize that the regulation of the DC Generator and the output of the inverter to match the load demands could be achieved. This will require a PLC based control system with the correct instrumentation devices.

People in this field would not realize that the regulation of pressures, temperatures, and flow rates for the closed loop hot water and cooling water systems could be achieved in a steady manner. This will require a PLC based control system with the correct instrumentation devices.

People in this field would not realize that it is economically feasible to implement this system. The efficiency of the Thermal Hydraulic DC Generator is much better than anything else available for this type of application. This is new technology and people in the field are not aware of its capabilities.

People in this field would not realize that so much energy is wasted in turbine generator exhaust systems. They would not realize that so much energy can be recovered and used to generate additional electricity with a Thermal Hydraulic DC Generator at such a low cost. Again, this is new technology, and people in the field are not aware of its capabilities.

People in this field would not realize that the Thermal Hydraulic DC Generator system meets “Green Energy” requirements. “Green Energy” qualifies for tax credits and can add to the savings when this type of system is installed. Again, this is new technology, and people in the field are not aware of its capabilities.

People in this field would not realize that so much energy can be wasted from utility steam systems that enter large buildings in lots of cities around the world. They would not realize that so much energy can be recovered and used to generate additional electricity with a Thermal Hydraulic DC Generator at such a low cost. Again this is new technology, and people in the field are not aware of its capabilities.

People in this field would not realize that this system is very flexible and can incorporate other forms of Green Energy sources through the use of a common inverter.

People in this field would not realize that the use of the DC Generator and the inverter to generate electricity at unity power factor can increase the efficiency of the system.

In various embodiments, waste energy is recovered from Turbine Generator or Combustion Engine Generator Exhaust Systems to produce hot water for co-generation to drive Thermal Hydraulic DC Generators.

In various embodiments, waste steam is recovered from utility systems to drive Thermal Hydraulic DC.

In various embodiments, energy from Combustion Engine Cooling Water Systems is recovered to produce hot water to drive Thermal Hydraulic DC Generators.

In various embodiments, the use of Solar Collectors is incorporated in conjunction with Thermal Hydraulic DC Generators. The Solar Collectors produce hot water to drive the Thermal Hydraulic DC Generators.

Various embodiments incorporate the use of Geothermal Sources in conjunction with Thermal Hydraulic DC Generators. The Geothermal Sources produce hot water to drive the thermal Hydraulic DC Generators.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

7. A system, comprising:
a thermal hydraulic DC generator, for generating DC output power in response to a control signal;
a grid tie inverter, for converting the DC output power into AC power for use by an electrical load; and
a controller, for adapting said control signal in response to an electrical system load demand associated with said electrical load, said control signal being adapted to cause said thermal hydraulic DC generator to adapt said DC output power such that said grid tie inverter satisfies said electrical system load demand.

8. The system of claim 7, wherein the thermal hydraulic DC generator comprises a DC generator driven by a hydraulic pump, the hydraulic pump driven by an engine, the engine driven by alternately circulating therein hot water and cool water, wherein a rate of alternately circulating said hot water and cool water therein is adapted in response to said control signal.

9. The system of claim 8, wherein:
said rate of alternately circulating said hot water and cool water is reduced in response to a control signal indicative of low electrical system load demand; and
said rate of alternately circulating said hot water and cool water is increased in response to a control signal indicative of high electrical system load demand.

10. The system of claim 8, wherein said hot water has a temperature of approximately 180° F. water, and said cool water has a temperature of approximately 80° F. water.

11. The system of claim 7, wherein the thermal hydraulic DC generator comprises a DC generator driven by a hydraulic pump, the hydraulic pump driven by an engine, the engine driven by alternately circulating therein hot water and cool water, wherein a flow rate of one or both of said hot water and cool water circulating therein is adapted in response to said control signal.

12. The system of claim 7, further comprising an engine heating cycle water heat exchanger for generating said hot water at a flow rate determined by a variable frequency drive (VFD) controlled circulating pump responsive to said control signal.

13. The system of claim 7, further comprising an engine cooling cycle water heat exchanger for generating said cool water at a flow rate determined by a variable frequency drive (VFD) controlled circulating pump responsive to said control signal.

14. The system of claim 12, wherein said engine heating cycle water heat exchanger thermally communicates with a power generation system to receive heat therefrom.

15. The system of claim 13, wherein said engine cooling cycle water heat exchanger thermally communicates with one or more cooling sources to deliver heat thereto.

16. The system of claim 7, wherein said AC power from said grid tie inverter and AC power from an electrical utility is coupled to said electrical load via electrical system switchgear, said AC power from said grid tie inverter being synchronized in frequency, phase and amplitude with respect to said AC power from said electrical utility.

17. The system of claim 7, wherein said AC power from said grid tie inverter and AC power from an electrical utility is coupled to said electrical load via electrical system switchgear, said AC power from said grid tie inverter being adapted to maintain a unity power factor in response to changes in electrical system load demand.

18. The system of claim 16, wherein AC power from a power generation system is coupled to said electrical load via said electrical system switchgear, said AC power from said grid tie inverter being adapted to maintain a unity power factor in response to changes in electrical system load demand.

19. The system of claim 12, wherein said engine heating cycle water heat exchanger receives heated water via thermal communication with one or more of a power generation system, a combustion engine, a geothermal source, and a solar collector.

20. Apparatus, comprising:
a thermal hydraulic DC generator, for generating DC output power for a grid tie inverter adapted to convert the DC power into unity power factor AC power for use by an electrical load, said thermal hydraulic DC generator adapting said DC output power in response to a control signal indicative of electrical system load demand associated with said electrical load such that said grid tie inverter satisfies said electrical system load demand.

21. The apparatus of claim 20, wherein the thermal hydraulic DC generator comprises a DC generator driven by a hydraulic pump, the hydraulic pump driven by an engine, the engine driven by alternately circulating therein hot water and cool water, wherein a rate of alternately circulating said hot water and cool water therein is adapted in response to said control signal.

22. The apparatus of claim 21, wherein:
said rate of alternately circulating said hot water and cool water is reduced in response to a control signal indicative of low electrical system load demand; and
said rate of alternately circulating said hot water and cool water is increased in response to a control signal indicative of high electrical system load demand.

23. The apparatus of claim 21, wherein said hot water has a temperature of approximately 180° F. water, and said cool water has a temperature of approximately 80° F. water.
